(19) United States
(12) Patent Application Publication
(10) Pub. No.: US 2014/0265898 A1
(43) Pub. Date: Sep. 18, 2014

(54) LOSSLESS PRELOAD FOR LED DRIVER WITH EXTENDED DIMMING

(71) Applicant: POWER INTEGRATIONS, INC., San Jose, CA (US)

(72) Inventors: Jose R. DEL CARMEN, JR., San Jose, CA (US); Marvin Cruz ESPINO, San Jose, CA (US)

(73) Assignee: Power Integrations, Inc., San Jose, CA (US)

(21) Appl. No.: 13/844,356

(22) Filed: Mar. 15, 2013

(51) Int. Cl. H05B 33/08

(52) U.S. Cl. CPC H05B 33/0815
USPC 315/200 R; 315/307

(57) ABSTRACT

A quasi-phase active preload circuit to be coupled at the output of a non-isolated LED driver converter having a pre-stage phase-angle control dimmer circuit, such as a commonly used leading-edge control Triac dimmer, is disclosed. The quasi-phase active preload circuit may include a preload resistor coupled to a current-controlled current source configured to draw a sinking current through the preload resistor based on a peak detect signal. The peak detect signal may be, in one example, representative of a leading-edge peak voltage of an output of the Triac dimmer circuit, which may be representative of a conduction angle of the Triac dimmer circuit. During normal operating conditions, no sinking current is drawn through the preload resistor. During low dimming conditions, a sinking current that is responsive to the peak detect signal is drawn through the preload resistor. During deep dimming or when used with a leaky Triac dimmer, a maximum sinking current may be drawn through the preload resistor by the current-controlled current source.

### BACKGROUND

1. Field

The present disclosure relates generally to circuits for driving light-emitting diodes (LEDs) and, more specifically, to LED driver circuits having phase-angle dimming circuitry.

2. Related Art

LED lighting has become popular in the industry due to the many advantages that this technology provides. For example, LED lamps typically have a longer lifespan, pose fewer hazards, and provide increased visual appeal when compared to other lighting technologies, such as compact fluorescent lamp (CFL) or incandescent lighting technologies. The advantages provided by LED lighting have resulted in LEDs being incorporated into a variety of lighting technologies, televisions, monitors, and other applications.

It is often desirable to implement LED lamps with a dimming functionality to provide variable light output. One known technology that has been used for analog LED dimming is the phase angle dimming either by leading edge or trailing edge control. In a known example, a Triac circuit can be used that operates by delaying the beginning of each half-cycle of alternating current (ac) power, which is known as “phase control.” By delaying the beginning of each half-cycle, the amount of power delivered to the load (e.g., the lamp) is reduced, producing a dimming effect in the light output by the lamp. In most applications, the delay in the beginning of each half-cycle is not noticeable to the human eye because the variations in the phase controlled line voltage and the variations in power delivered to the lamp occur so quickly. For example, Triac dimming circuits work especially well when used to dim incandescent light bulbs since the variations in phase angle with altered ac line voltages are immaterial to these types of bulbs. However, flicker may be noticed when Triac circuits are used for dimming LED lamps.

Flickering in LED lamps can occur because these devices are typically driven by LED drivers having regulated power supplies that provide regulated current and voltage to the LED lamps from ac power lines. Unless the regulated power supplies that drive the LED lamps are designed to recognize and respond to the voltage signals from Triac dimming circuits in a desirable way, the Triac dimming circuits are likely to produce non-ideal results, such as limited dimming range, flickering, blinking, and/or color shifting in the LED lamps.

The difficulty in using Triac dimming circuits with LED lamps is in part due to a characteristic of the Triac itself. Specifically, a Triac is a semiconductor component that behaves as a controlled ac switch. Thus, the Triac behaves as an open switch to an ac voltage until it receives a trigger signal at a control terminal, causing the switch to close. The switch remains closed as long as the current through the switch is above a value referred to as the “holding current.” Most incandescent lamps draw more than the minimum holding current from the ac power source to enable reliable and consistent operation of a Triac. However, the comparably low currents drawn by LEDs from efficient power supplies may not meet the minimum holding currents required to keep the Triac switches conducting for reliable operation. As a result, the Triac may trigger inconsistently. In addition, due to the inrush current charging the input capacitance and because of the relatively large impedance that the LEDs present to the input line, a significant ringing may occur whenever the Triac turns on. This ringing may cause even more undesirable behavior as the Triac current may fall to zero and turn off the string of LEDs, resulting in a flickering effect.

To address these issues, conventional LED driver designs typically rely on current drawn by a dummy load or “bleeder circuit” of the power converter to supplement the current drawn by the LEDs in order to draw a sufficient amount of current to keep the Triac conducting reliably after it is triggered. These bleeder circuits typically include passive components and/or active components controlled by the converter parameters or by the load level. While useful to draw additional current, a bleeder circuit that is external to the integrated circuit requires the use of extra components with associated penalties in cost and efficiency.

### BRIEF DESCRIPTION OF THE DRAWINGS

Non-limiting and non-exhaustive embodiments are described with reference to the following figures, wherein like reference numerals refer to like parts throughout the various views unless otherwise specified.

FIG. 1 shows a general block diagram of an offline LED driver with Triac phase control dimming according to various examples.

FIG. 2A is a block diagram illustrating an example quasi-phase active preload according to various examples.

FIG. 2B is a schematic illustrating a circuit diagram of an example quasi-phase active preload according to various examples.

FIG. 3 is a block diagram illustrating an example quasi-phase active preload for use with a Buck-Boost converter according to various examples.

FIG. 4 is a schematic illustrating a circuit diagram of an example quasi-phase active preload for use with a Buck-Boost converter according to various examples.

FIG. 5 is a block diagram illustrating an example quasi-phase active preload for use with a Buck converter according to various examples.

FIG. 6 is a schematic illustrating a circuit diagram of an example quasi-phase active preload for use with a Buck converter according to various examples.

FIGS. 7A, 7B, and 7C illustrate sample waveforms of voltage and current in an example quasi-phase active preload during a line cycle according to various examples.

### DETAILED DESCRIPTION

In the following description, numerous specific details are set forth in order to provide a thorough understanding. It will be apparent, however, to one having ordinary skill in the art that the specific details need not be employed.

Various embodiments directed to quasi-phase active preload circuitry for an LED driver implementing phase-angle dimming are disclosed. The quasi-phase active preload circuitry disclosed in this application may be used with any type of phase-angle control dimmer that either controls the leading edge or trailing edge of the line voltage cycle. In a more specific example explained in greater detail below, it may be used with a Triac leading edge phase-angle control dimmer by indirectly (e.g., through leading edge peak detection) being responsive to the Triac conduction angle, which is referred to as quasi-phase detection. The circuitry provides a reliable and improved performance with extended dimming ratio and high efficiency for the LED driver with a pre-stage phase control Triac dimmer. It should be appreciated that while the examples provided below refer to Triac dimmers with leading-edge phase-angle control, the quasi-phase active preload circuitry may be similarly used with any other phase-angle control dimmer applications.

As mentioned above, typical low-cost Triac dimmers often have poor performance at deep dimming due to the leaky Triac performance (e.g., due to input filter capacitor leakage current that may cause undesirable on/off blinking of the LED). In one example, the quasi-phase active preload circuit improves performance of the LED driver in low or deep dimming conditions and extends the dimming ratio by reducing or preventing shimmering/blinking of the LED lamp with little to no effect on efficiency at normal operation.

The disclosed quasi-phase active preload circuitry advantageously remains fully ON (closed switch) to prevent flicker when the LED load is in an off state or when a leaky Triac would otherwise turn on and cause an undesirable flicker in the LED. Additionally, during non-dimming operation, the quasi-phase active preload circuitry may not be activated (open switch) and may not dissipate power, resulting in little to no reduction in efficiency. During low dim operation below a predefined threshold conduction angle of the Triac (e.g., below a threshold of 70° conduction angle), the switching device of the quasi-phase active preload circuitry may operate in a linear mode and sink a current inversely proportional to the Triac conduction angle. In this mode, the quasi-phase active preload may be controlled in response to the level of dimming through a “peak detect signal” that is a quasi-phase representation of the Triac conduction angle. In this way, the dimming ratio can be extended without sacrificing efficiency at non-dimming operation.

To illustrate, FIG. 1 shows a general block diagram of an LED driver 100 including a regulated converter 130 and a Triac dimming circuit 104. As shown, a pre-stage Triac dimming circuit 104 is coupled to the input ac line signal V_{AC} 102, in reference to ground 101, through a fusible protection device 103 to provide leading-edge phase control of Triac conduction for the sinusoidal input voltage of the input ac line signal V_{AC} 102. The leading edge phase controlled Triac dimming circuit 104 operates by delaying the beginning of each half-cycle of input ac line signal V_{AC} 102 and is symbolized by the waveform 105. By delaying the beginning of each half-cycle of the input ac line signal V_{AC} 102 with Triac dimming circuit 104, the amount of power delivered to the load (e.g., a lamp) 175 is reduced and the light output by the LED appears dimmed.

The leading-edge phase control of Triac conduction is fed to the bridge rectifier 110 through the electromagnetic interference (EMI) filter 108. As shown in the depicted example, the rectified voltage V_{RECT} 112 (represented by symbolic waveform 115) produced by the bridge rectifier 110 has a conduction phase angle controlled in each half line cycle in response to the Triac dimming circuit 104. The rectified voltage V_{RECT} 112 provides an adjustable average dc voltage to a high frequency regulated converter 130 through some required or optional input circuitry 118 that may include interface devices/blocks, such as an input bleeder, damper, inductive and capacitive filter, and/or other blocks depending on the application.

As illustrated in the sequential blocks of FIG. 1, an example peak detector circuit 120 is coupled between input circuitry 118 and regulated converter 130. In one example, the peak detector circuit 120 may include a rectifier (diode) 122 for charging the capacitor 126 to the peak of the leading edge of rectified voltage V_{RECT} 112 (distinguished from the absolute peak of the rectified voltage V_{RECT} 112). Peak detector circuit 120 may further include resistor 124 coupled to the rectifier 122 to provide a timely discharge of the capacitor 126. Peak detector circuit 120 may output a leading edge peak detect signal 128 having a voltage corresponding to the charge stored on capacitor 126. The leading edge peak detect signal 128 is referenced to the input ground 101 and represents the leading edge peak voltage of the rectified voltage V_{RECT} 112 (corresponding to the Triac conduction angle).

In some examples, the rectified voltage V_{RECT} 112 may be unaffected by the input circuitry 118 and peak detector circuit 120 and may be applied to the input terminal of the regulated converter 130 having controller 135. It is appreciated that the regulated converter 130 may be non-isolated with an output ground 113 that is different (shifted) than input ground 101. Examples of such the converters may include, but are not limited to, non-isolated Buck-Boost converters, Buck converters, and Tapped Buck converters with a switch and/or an inductor on the return line that may result in an output ground 113 that is level-shifted from the input ground 101.

In one example, the controller unit 135 included in the regulated converter 130 is referenced to the input ground 101. The regulated output of the converter 130 across the bulk capacitor 138, before applying the output voltage V_{O} 170 and providing current I_{O} 171 to the load 175 at terminals 172 and 174, may pass through the interface of quasi-phase active preload circuit 160. The quasi-phase active preload circuit 160 may receive the leading edge peak detect signal 128 (representative of Triac conduction angle) from peak detector circuit 120 and may sink a current in response to the leading edge peak detect signal 128. It is appreciated that while the quasi-phase active preload circuit 160 is referenced to the output ground 113, it may also be referenced to input ground 101 of the leading edge peak detect signal 128 to compensate for possible fluctuations between the input/output ground reference levels.

In the depicted example, capacitor 126 of peak detector circuit 120 is charged via diode 122 to the ac leading edge peak of rectified voltage V_{RECT} 112 and provides information regarding the leading edge peak of the Triac controlled line voltage to the controller 135 (e.g., fed as a current to controller 135 via a resistor) to monitor the line voltage level that may also be utilized to set over-voltage and under-voltage protection. Resistor 124 provides a discharge path for capacitor 126 with a relatively long time constant to prevent modulation of line frequency current at the controller terminal.

FIG. 2A illustrates a block diagram of an example quasi-phase active preload circuitry 260 that may be used as quasi-phase active preload circuit 160 of FIG. 1. In a regulated converter 230 of an LED driver, the quasi-phase active preload circuitry 260 may be activated to sink current at low dimming conditions below a threshold conduction angle of the Triac (leading edge control) in response to a leading edge peak detection signal 228 of the rectified voltage V_{RECT} 212 (represented by waveform 215) that is a representative of (proportional to) the Triac conduction angle. At wide/large Triac conduction angles (e.g., high load and no dim), the quasi-phase active preload may not be activated and may not consume any power, resulting in a minimal reduction in efficiency (no loss/no power consumption) at normal operation of the LED driver. During Triac off conditions or below a second lower Triac conduction angle threshold (e.g., the leading edge peak value is near zero), the quasi-phase active preload may remain fully on to prevent any undesirable LED turn on and flickering.

The quasi-phase active preload circuitry 260 is coupled to receive the leading edge peak detect signal 228 from the peak detector circuit 220 at the input stage of the converter 230. The leading edge peak detect signal 228 is representative of the Triac conduction angle. The rectified phase controlled input voltage V_{RECT} 212 from input circuitry (e.g., input circuitry 118 of FIG. 1) is applied to the peak detector circuit 220 and charges capacitor 226 through diode 222 and resistor 224 to the leading edge peak of rectified voltage V_{RECT} 212, generating peak detect signal 228 that may be utilized by quasi-phase active preload circuit 260 and controller 235. The regulated dc voltage at the output of regulated converter unit 230 is filtered by the output bulk capacitor 238 to smooth the output before applying it to the dc load (e.g., an LED string).

The quasi-phase active preload circuitry 260 is responsive to the leading edge peak of rectified voltage V_{RECT} 210 (representing the Triac conduction angle) and is coupled between regulated converter unit 230 and load terminals 272 and 274. An output voltage V_{O} 270 and current I_{O} 271 may be provided to a load (e.g., one or more LEDs, not shown) coupled between load terminals 272 and 274. The quasi-phase active preload circuitry 260 may not affect the filtered voltage V_{O} 270 across the bulk output capacitor 238 that is to be applied to the dc load. Quasi-phase active preload circuitry 260 may include resistor 262 coupled as a preload to sink a controlled current through the current controlled current source block 269A that, in one example, may include a linear mode switching device as shown in block 269B in FIG. 2B. The current controlled current source block 269A is controlled by a control current I_{C} in such a way that at no dimming operation or at Triac conduction angles higher than a predefined threshold, no current is sank through the preload resistor 262 and no losses may affect efficiency of the system. However, at low conduction angles of Triac dimming that are below the threshold (e.g., below a conduction angle of about 70°), the control current I_{c} triggers the current controlled current source 269A to sink a preload current that is inversely proportional to the reduced leading edge peak voltage of the phase controlled rectified voltage V_{RECT} 212.

In some of common LED driver topologies with non-isolated regulated converters, such as Buck-Boost converters, Buck converters, and Tapped Buck converters, in which the switching device and/or inductor may be placed on the input line return (low potential side), the output reference ground 202 in different modes of operation may fluctuate relative to the input reference ground level 201. As a result, conventional preloads at the output of the converter cannot be easily controlled using a signal that is referenced to the input line ground. Thus, quasi-phase active preload circuit 260 compensates for fluctuations between input and output grounds. In particular, control current I_{C} is a compensated current generated by block 261A to control the preload current source 269A. The control current compensation block 261A is referenced to the output terminal 274 (also output reference ground 202) and receives a current I_{A} from output terminal 272, to generate the control current Ic for the preload adjustment. The control current Ic is generated by a subtraction of compensation current I_{B} from I_{A}. The compensation current I_{B} is inversely proportional to the leading edge peak of the Triac phase controlled voltage or phase controlled rectified voltage V_{RECT} 212. The current I_{A} is compensated by subtracting a compensation current I_{B} that is sank through a voltage controlled current source 280A referenced to the input ground 201. The voltage controlled current source 280A is controlled by a signal 279A, which is a scaled version of peak detect signal 228, generated by block 284A, which is referenced to the input ground 201.

In a leading edge control of Triac dimmer, at dimming condition wherein Triac cuts above 90° of line half cycle, the leading edge peak of the remaining portion of the line half cycle (conduction angle <90°) reduces as dimming increases (conduction angle reduces), resulting in a higher compensation current I_{B}.

During a non-dimming condition, when conduction angles >90° of line half cycle in which the absolute peak of the line voltage is detected, or for conduction angles <90° that results in a leading edge peak above a threshold voltage (related to a predefined conduction angle, for example, typically) >70°, the compensation current I_{B} sinks all or nearly all of the current I_{A}, leaving the current source 269A generating no current (since I_{C}=I_{A}−I_{B}), meaning that that the preload remains inactive with zero consumption.

Additionally, when used with a leaky Triac in which capacitive leakage current at the input filter and/or possible current oscillations at deep dimming may cause false triggering of Triac, the quasi-phase active preload circuit 260 may prevent undesirable LED flickering. In particular, during Triac off conditions in which the leading edge peak is zero or negligible, the compensation current I_{B} remains at or near zero and the control current I_{C} is at its maximum value, keeping the preload sinking maximum current to prevent flickering.

FIG. 2B illustrates an example implementation of the quasi-phase active preload circuitry 260. Elements in FIG. 2B having the same reference number as an element in FIG. 2A may be implemented using a similar or identical device as that described above with respect to FIG. 2A. Similar to the example shown in FIG. 2A, quasi-phase active preload circuitry 260 in FIG. 2B includes preload resistor 262 for sinking a controlled current through the current controlled current source block 269B. In the illustrated example, block 269B includes a Darlington configuration of transistors Q1, 267 and Q2, 268 used as the switching device in linear mode that provides a current controlled current source for the quasi-phase active preload.

Quasi-phase responsive quasi-phase active preload circuitry 260 further includes capacitor 266 for noise decoupling and filtering the voltage between the base of transistor Q1, 267 and the emitter of transistor Q2, 268. A diode 264 may also be included to limit the base to emitter voltage between transistors Q1, 267 and Q2, 268. A bias resistor 261B may be used to set the starting point of the preload operation. Resistor 265 may be used as a discharge resistor to speed up the dynamic response and bleeds (due to the overcharge of capacitor 266), preventing or reducing the leakage from the Darlington combination of transistors Q1, 267 and Q2, 268. Resistor 263 compensates the biasing current to the preload switching device. Resistor 281 is the emitter gain stabilizer for the transistor 280B. Resistor 284B is the base gain limiting resistor for the transistor 280B. Resistors 282 and 283 are the bias resistors for the linear operation of the transistor 280B in the voltage-to-current signal conversion block.

One application for the quasi-phase active preload circuit described above is in a Buck Boost non-isolated power converter, such as that shown in FIG. 3. In FIG. 3, input terminal 324 is coupled to bridge rectifier 110 (depicted in FIG. 1) and input circuitry 318, which, in one example, may include a damper, bleeder, or other common input interface circuitry used in a typical LED driver. The rectified voltage V_{RECT} 312 (represented by waveform 315) outputted from input circuitry 318 is transferred to the peak detector circuit 320. In one simple example, the peak detector circuit 320 is similar or identical to circuit 120 of FIG. 1 and may include a rectifier (diode) 322 charging capacitor 326 to the leading edge peak of rectified phase controlled input voltage 315. Peak detector circuit 320 may further include resistor 324 coupled to diode 322 to provide a timely discharge of the capacitor 326. Peak detector circuitry 320 may generate peak detect signal 328, which may be used in the quasi-phase active preload circuit 360 and controller 355.

The rectified phase controlled input voltage V_{RECT} 312 is then transferred from peak detector circuit 320 to the input terminal of regulated Buck-Boost converter 330. Buck-Boost converter 330 may provide an output voltage Vo 370 and output current Io 371 to load 375. The regulated Buck-Boost converter 330 is referenced to output ground 302 and includes an energy transfer inductor L1, 331, a freewheeling (circulating) diode 341, and power switch 340. Diode 334 may also be included to prevent the current return from power switch 340 to the inductor 331 due to possible oscillations in voltage across the switch 340. The auxiliary isolated winding 332 on the inductor 331 provides an anti-phase voltage (flyback action depicted by anti-phase dots of windings 331 and 332) and is referenced to the primary ground 301.

The primary side control of converter 330 is provided by utilizing the auxiliary winding 332 on the energy transfer inductor L1 331 to sense the output voltage indirectly and provide a feedback signal representative of output voltage V_{O} 370 on FB terminal 354, which is referenced to the input ground 301, and eliminates the need for extra isolating feedback components, such as opto-couplers. The voltage on the auxiliary winding 332 (also called bias winding) is proportional to the output voltage V_{O} 370, as determined by the turns ratio between windings 331 and 332. In one example, the voltage on auxiliary winding 332 is also used to generate the bias supply at BP terminal 352 of controller 355.

The auxiliary winding 332, through the bias (BP) and feedback (FB) circuitry 335, can be utilized as a bias supply to provide power for the controller 355 (on BP terminal 352 of controller 355) and may be used to provide the feedback information regarding output voltage Vo 370 (across the output bulk capacitor 338) to the feedback terminal 354 of controller 355. Switching action of switch 340 is controlled via a drive signal 339 from controller 355, which, in one example, may be included in an integrated circuit (IC) package 350 with switch 340. Controller 355 is referenced to input (primary) ground 301 and may also include terminals for receiving leading edge peak detect signal 328 and switch current signal 336. Controller 355, in one example, may include additional terminals, such as resistor select terminal R 321 that, based on value of an external resistor 325 coupled to this terminal, may select between different modes of operation.

The output terminals of the regulated Buck-Boost converter 330 are applied to the output bulk capacitor Co 338 coupled to quasi-phase active preload circuit 360. In a Buck-Boost power converter, the return line at load 375 side is referenced to the high level input line (V_{RECT} 312 on the top side of inductor 331). In the non-isolated converters, such as Buck-Boost of FIG. 3 or Buck converter of FIG. 5 having a switching device on the input return line, the output return line at load side may not in all modes of operation be referenced to the input return line, and special consideration should be paid to the possible errors due to this effect. The present disclosure introduces features to improve such an error.

FIG. 4 illustrates an example implementation of the circuit blocks in FIG. 3. In this example, an input terminal to peak detector circuit 420 is coupled to input circuitry 418, which may be similar or identical to input circuitry 318 and 118 in FIGS. 3 and 1, respectively. In one example, the input circuitry may include a damper, bleeder, or other common input interface circuitry used in a typical LED driver. Additionally, quasi-phase active preload circuit 460 may be similar or identical to quasi-phase active preload circuitry 260 shown in FIG. 2, where similarly numbered elements (261B, 262-268, 269B, and 279-284; 461-468 and 479-484) represent similar or identical devices. However, it should be appreciated that the actual values of the components may vary based on the application.

The peak detector circuit 420 shown in FIG. 4 is similar or identical to circuits 120, 220, and 320 of FIGS. 1, 2 and 3, respectively. In particular, peak detector circuit 420 includes capacitor 426, which may be charged through diode 422 to the leading edge peak of rectified phase controlled input voltage V_{RECT} 412 (represented by waveform 415). Peak detector circuit 420 further includes resistor 424 for providing a discharge path for the capacitor 426. Peak detector circuit 420 receives the rectified voltage V_{RECT} 412 from the input circuitry and generates the leading edge peak detect signal 428 that may be used by quasi-phase active preload circuit 460 and controller 455.

The rectified phase controlled voltage V_{RECT} 412 outputted by peak detector circuit 420 may be transferred to the input terminal of regulated Buck-Boost converter 430. Buck-Boost converter 430 includes energy transfer inductor L1, 431, freewheeling/circulating diode 441, and switch 440 which, in one example, includes a power MOSFET controlled by a controller 455 via drive signal 439 to regulate the output of the converter. Transfer of energy from input line to the output load 475 may be performed through switching action of switch 440 controlled by controller 455 that, in one example, may be included in a monolithic IC package 450 with switch 440.

Converter 430 may include current-blocking diode 434 for preventing current return from the switch 440 to the inductor 431 due to oscillations across the switch 440. The basic principle of operation of Buck-Boost converter 430 is to charge the inductor L1 431 when switch 440 is closed and no energy is transferred to the output capacitor Co 438 (output voltage V_{O} 470 and output current Io 471 during switch on-time are provided by the stored charge in output bulk capacitor Co 438). During the on-time of switch 440, the voltage across the inductor L1 431 is the rectified phase controlled input voltage V_{RECT} 412. When switch 440 opens, the energy stored in inductor L1 431 may be transferred through diode 441 to the load 475 and output bulk capacitor Co 438. The voltage across the inductor L1 431 during switch off-time is the rectified phase controlled input voltage V_{RECT} 412 minus the output voltage V_{O} 470. The auxiliary winding 432 is wound on the same core of inductor 431 and has a flyback function (as indicated by the anti-phase dots on windings 431 and 432) and is referenced to the primary ground 401 to directly feed the signals to the controller 455, which is also referenced to primary ground 401. The pulsating voltage across auxiliary winding 432 is rectified through diode 444 in series with damping resistor 443 and then filtered out through capacitor 445 and resistor 446. The dc filtered voltage output by auxiliary winding 432 at node 490 is applied to BP terminal 452 through diode 458 and resistor 451. This dc filtered voltage may be used as the supply to the internal blocks of controller 455. The rectified and filtered voltage of auxiliary winding 432 at node 490 may also be indirectly representative of the output voltage V_{O} 470 and may be used to apply a feedback current through resistors 491 and 453 to the FB terminal 454 of controller 455.

The auxiliary winding 432 through the diode 442 and capacitor C2 448 in parallel with discharge resistor 499 can also provide a fast transient response output at node 495 that, through Zener diode 496 and resistors 497 and 498, may bias transistor Q3 492 above a threshold defined by the trigger level of Zener diode 496. Capacitor 493 functions as noise decoupling at the base of transistor Q3 492. During the overshoots across capacitor C2 448 above the threshold of Zener diode 496, transistor 492 pulls down the FB terminal 454 through resistor 453.

Controller 455 is a primary side controller that is referenced to the input (primary) ground 401. All input signals to controller terminals, including the leading edge peak detect signal 428, may also be referenced to input ground 401. The switch current signal 436 may be internally and directly (inside the monolithic IC package 450) coupled to the controller 455 to be compared to a current limit level. In one example, controller 455 may include additional terminals, such as resistor select terminal R 421 that, based on the value of the external resistor 423 on this terminal, may select between different modes of operation.

The regulated output voltage V_{O} 470 terminals of Buck-Boost converter 430 across the output bulk capacitor C_{O}438 and at the interface of load 475 may be first applied to the quasi-phase active preload 460. In a Buck-Boost power converter, the return line at load side is referenced to the high level input line (V_{RECT} 412 on node 429 at the top side of inductor 431). In the non-isolated converters, such as Buck-Boost of FIGS. 3-4 or Buck converter of FIGS. 5-6, having an inductor and/or switching device between the input-output return lines, the output return line at load side may not in all modes of operation be referenced to the input return line, and special consideration should be paid to the possible errors due to this effect. The present disclosure introduces features to improve such an error.

Another example application of the quasi-phase active preload circuit described above is in a non-isolated Buck power converter with low side switch and/or inductor, wherein the switching device and/or inductor is located on return line, such as that shown in FIG. 5. In FIG. 5, the input terminal coupled to peak detector circuit 520 is also coupled to the output of input circuitry (e.g., input circuitry 118 depicted in FIG. 1), which, in turn, is coupled to a bridge rectifier (e.g., bridge rectifier 110 depicted in FIG. 1). In one example, the input circuitry may include a damper, bleeder, or other common input interface circuitry used in a typical LED driver. The rectified phase controlled voltage V_{RECT} 512 (represented by waveform 515) is transferred to peak detector circuit 520, which may include similar components and operate in a similar manner as described above with respect to circuits 120, 220, 320, and 420 of FIGS. 1, 2, 3, and 4, respectively. In particular, peak detector circuit 520 may include rectifier (diode) 522 for charging capacitor 526 to the peak of the leading edge of rectified phase controlled input voltage V_{RECT} 512. Peak detector circuit 520 may further include resistor 524 coupled to the diode 522 to provide a path for discharge of capacitor 526. Peak detector circuit 520 may output peak detect signal 528, which may be used in controller 555 and in the quasi-phase active preload circuitry 560, which is referenced to output ground 502.

The rectified phase controlled voltage V_{RECT} 512/515 is then transferred from peak detector circuit 520 to the input terminal of regulated Buck converter 530. Buck converter 530 may include energy transfer inductor L1, 531, a freewheeling/circulating diode 541, and switching device 540. A diode 534 may also be included to prevent current return from the switch 540 to the inductor 531 due to any possible voltage oscillation during turn-off across switch 540. Buck converter 530 operates by charging inductor L1 531 and transferring energy to the output capacitor 538 and load 575 when the switching device 540 is closed. During switch off-time, the inductor discharging current is freewheeling/circulating through the diode 541 and the output voltage V_{O} 570 and output current I_{O} 571 are provided by the stored charge in output bulk capacitor C_{O} 538. During the on-time of switch 540, the voltage across inductor L1 531 is equal to the rectified voltage V_{RECT} 512 minus the output voltage V_{O} 570. During the off-time of switch 540, the voltage across the inductor L1 531 is equal to the output voltage V_{O} 570.

The auxiliary isolated winding 532 may be on the same core of the inductor 531 and may provide an anti-phase voltage (flyback action depicted by anti-phase dots of windings 531 and 532) that is referenced to the primary ground 501. The auxiliary winding 532 is used by bias (BP) and feedback (FB) circuitry 535 to provide power to the controller 555 (at BP terminal 552) and, during switch off-time, to provide the feedback information regarding the output voltage (across the output bulk capacitor 538) to the feedback terminal FB 554 of controller 555. Switching action of switch 540 is controlled via a drive signal 539 from controller 555 that, in one example, may be included in a single IC package 550 with the switch 540. Controller 555 is referenced to input (primary) ground 501 and may further include terminals for receiving leading edge peak detect signal 528 and switch current signal 536. Controller 555, in one example, may include additional terminals, such as resistor select terminal R 521 that, based on value of an external resistor 523 coupled to this terminal, may select between different modes of operation.

The output terminals of regulated Buck converter 530 is applied to the output bulk capacitor C_{O} 538 and the output voltage V_{O} 570 at the interface of load 575 may be first applied to the quasi-phase active preload 560. In this non-isolated Buck converter and other non-isolated converters, such as Buck-Boost of FIG. 3, that include a switching device on the input return line, the output return line at load side may not in all modes of operation be referenced to the input return line, and special consideration should be paid to the possible errors due to this effect. The present disclosure introduces features to improve such an error.

FIG. 6 illustrates an example implementation of the circuit blocks in FIG. 5. Quasi-phase active preload circuit 660 may be similar or identical to quasi-phase active preload circuitry 260 shown in FIG. 2, where similarly numbered elements (261B, 262-268, 269B, and 279-284; 661-668 and 679-684) represent similar or identical devices. However, it should be appreciated that the actual values of the components may vary based on the application.

The input terminal coupled to peak detector circuit 620 is also coupled to input circuitry (e.g., input circuitry 118 in FIG. 1), which, in turn, is coupled to a bridge rectifier (e.g., bridge rectifier 110 in FIG. 1). The input circuitry may include different varieties of a damper, bleeder, or other common input interface circuitry used in a typical LED driver. The peak detector circuit 620 may be similar or identical to peak detector circuits 120, 220, 320, 420, or 520 of FIGS. 1-5. In particular, peak detector circuit 620 may include capacitor 626 to be charged through diode 622 to the leading edge peak of rectified phase controlled input voltage V_{RECT} 612 (represented by waveform 615). Peak detect circuit 620 further includes resistor 624 for providing a discharge path for capacitor 626. Peak detector circuit 620 receives the rectified phase controlled input voltage V_{RECT} 612 from the input circuitry and generates the leading edge peak detect signal 628, which may be used in the quasi-phase active preload circuitry 660 and controller 655.

The rectified phase controlled input voltage V_{RECT} 612 is then transferred to the input terminal of regulated Buck converter 630 (not labeled to avoid clutter in the figure). Buck converter 630 may include energy transfer inductor L1, 631, a freewheeling/circulating diode 641, and switching device 640. A diode 634 may also be included to prevent current return from the switch 640 to the inductor 631 due to any possible voltage oscillation during turn-off across switch 640. Buck converter 630 operates by charging inductor L1 631 and transferring energy to the output capacitor 638 and load 675 (not shown) through the quasi-phase active preload circuitry 660 when the switching device 640 is closed. During switch off-time, the inductor discharging current is freewheeling/circulating through the diode 641 and the output voltage V_{O} 670 and output current I_{O} 671 are provided by the stored charge in output bulk capacitor C_{O} 638. During the on-time of switch 640, the voltage across inductor L1 631 is equal to the rectified voltage V_{RECT} 612 minus the output voltage V_{O} 670. During the off-time of switch 640, the voltage across the inductor L1 631 is equal to the output voltage V_{O} 670.

The auxiliary isolated winding 632 may be on the same core of the inductor 631 and may provide an anti-phase voltage (flyback action depicted by anti-phase dots of windings 631 and 632) that is referenced to the primary ground 601. The auxiliary winding 632 is used by bias (BP) and feedback (FB) circuitry to provide power to the controller 655 at BP terminal 652 and, during switch off-time, to provide the feedback information regarding the output voltage V_{O} 670 (across the output bulk capacitor 638) to the feedback terminal FB 654 of controller 655. The auxiliary winding 632 is referenced to input ground (source terminal of MOSFET switching device 640). The pulsating voltage across auxiliary winding 632 is rectified through diode 644 and damping resistor 643 and filtered through capacitor C1 645 and resistor 646. The dc filtered voltage output by auxiliary winding 632 at node 690 is applied to BP terminal 652 through diode 658 and resistor 651. This dc filtered voltage may be used as the supply to the internal blocks of controller 655. The rectified and filtered (averaged) voltage of auxiliary winding 632 at node 690 may also be indirectly representative of the output voltage V_{O} 670 and may be used to apply a feedback current through resistors 691 and 653 to the FB terminal 654 of controller 655.

The auxiliary winding 632 through the diode 642 and capacitor C2 648 in parallel with discharge resistor 699 can also provide a fast transient response output at node 695 that, through Zener diode 696 and resistors 697 and 698, may bias transistor Q3 692 above a threshold defined by trigger level of Zener diode 696. Capacitor 693 functions as noise decoupling. During overshoots across capacitor 648 above the Zener diode 696 threshold, transistor Q3 692 pulls down the FB terminal 654 through resistor 653.

Transfer of energy from the input line to the output load may be performed through switching action of switch 640 controlled via drive signal 639 from controller 655 that, in one example, may be included in a monolithic IC package 650 with switch 640.

Controller 655 is a primary side controller that is referenced to input (primary) ground 601. All input signals to controller terminals, including the leading edge peak detect signal 628, may also be referenced to input ground 601. In this example of controller 655, the switch current signal 636 is directly monitored inside controller 655 to be compared to a current limit level. Controller 655, in one example, may include additional terminals, such as resistor select terminal R 621 that, based on value of an external resistor 623 coupled to this terminal, may select between different modes of operation.

The regulated output terminals of Buck converter 630 are applied to the output bulk capacitor C_{O} 638 coupled to quasi-phase active preload circuit 660. In a Buck power converter having a switch and/or inductor at return line, the output return at load side may be at a different reference level compared to the input ground reference level. In the non-isolated converters, such as Buck-Boost of FIGS. 3-4 or Buck converter of FIGS. 5-6 having a switching device on the input return line, the output return line at load side may not in all modes of operation be referenced to the input return line, and special consideration should be paid to the possible errors due to this effect. The present disclosure introduces features to improve such an error.

FIGS. 7A-C illustrate example waveforms at different nodes of a converter and quasi-phase active preload circuitry. FIG. 7A shows the input ac line voltage and current in a line cycle period T 701 for a Triac leading edge cutoff φ_{cut} 722 in which the conduction angle α φ_{cond} 724 is above the quasi-phase active preload threshold of activation. For example, the conduction angle may fall below 70° or cutoff angle may increase above 110° to enable switching device 469/669 of quasi-phase active preload 460/660 in FIGS. 4 and 6, respectively. In this example, the line voltage has a cut portion 711 (represented by a dashed line) and a conduction portion Vᵢₙ 710 (represented by a solid line). In each half line cycle at the start of the leading edge of the phase controlled input voltage, the charging current of the bulk capacitor generates a spike 714. It is appreciated that in some examples, due to input filter capacitance and the presence of parasitic inductance, some oscillation may also occur (not shown) before the current settles back to the sinusoidal trace Iᵢₙ 712).

For conduction angles φ_{cond}>90, the peak detector circuit 420/620 may charge the peak detect capacitor 426/626 to the absolute (maximum) peak value of the sinusoidal input voltage, causing the leading edge peak detect signal 428/628 to go maximum high. As a result, the scaled down signal at the base of the compensation transistor 480/680 (referred to FIG. 4 and FIG. 6) may remain switched on (short circuit mode), causing a sinking of the full compensation current I_{B} 725. This causes the control current I_{C}=I_{A}−I_{B}, which is the bias current of the quasi-phase active preload switching device, to be substantially zero (pulled low), keeping the switching device of the quasi-phase active preload at an off-state with substantially a zero current 725 and a flat voltage 720 across it that represents the output voltage Vo. As can be observed in waveforms of voltage 720 across the preload switch 469/669 and current 725 through the preload switch 469/669, the signals remain relatively flat except for small deviations corresponding to occurrences of spikes 714 in the charging current of the bulk capacitor.

The component values should be selected such that even when the conduction angle falls below 90° and before reducing below the preload activation threshold (e.g., Triac conduction angle still above 70°), the bias/control current I_{C} drawn to the quasi-phase active preload switching device 469/669 should keep the switching device 469/669 at off-state and prevent it from entering the linear mode.

However, when the conduction angle of the Triac goes lower than the preload activation threshold (e.g., lower than 70°) resulting in a below threshold reduction in the leading edge peak detect signal, the compensation transistor 480 in FIG. 4 or 680 in FIG. 6 may transfer from ON-state mode to a linear mode to sink less current. This may result in a higher control/bias current for the preload switching device, letting it transfer from an off-state to a linear mode (acting as current controlled current source) to apply a preload that increases with a reduction of the leading edge peak signal (inversely proportional to the Triac conduction angle).

In FIG. 7B the example of waveforms of FIG. 7A are introduced at a low dimming condition wherein the conduction angle is below the activation threshold of the preload switching device. In one example, the conduction angle may have gone below 70°, the cutoff angle may be above 110°, and the switching device of quasi-phase active preload is enabled/activated.

Similar to FIG. 7A, FIG. 7B illustrates that during the line period T 701, the Triac controlled input line voltage has a cut portion 731 (represented by a dashed line) and a conduction portion Vᵢₙ 730 (represented by a solid line). In each half line cycle at the leading edge of Triac conduction, the charging current of the bulk capacitor generates a spike 734. It is appreciated that in some cases in the presence of the parasitic inductance, some oscillation could also be observed before the current spike 734 settles to the sinusoidal trace Iᵢₙ 732.

In FIG. 7B the Triac controlled input line voltage has a cutoff angle φ_{cut} 742. In one example, φ_{cut}>110° and the conduction angle φ_{cond} 744 <70°, which is below the preload threshold of activation. Referring to FIGS. 4 and 6, the peak detector circuit 420/620 charges the peak detect capacitor 426/626 to a leading edge peak detect signal 428/628. In one example, the resistor values 482/682, 483/683, and 484/684 of the scaled down leading edge peak detect signal at the base of compensation transistor 480/680 are designed to keep this transistor in a linear mode for φ_{cond}<70° (functioning as voltage controlled current source) and cause the transistor 480/680 to sink a compensation current (I_{B} in FIG. 2A) proportional to the Triac leading edge peak detect signal 428/628. The bias resistors of the preload switching device may be designed such that, in one example, for φ_{cond}<70°, the control/bias current I_{C} of the preload switching device (I_{C}=I_{A}−I_{B}, in FIG. 2A) may keep the transistor in a linear mode (functioning as current controlled current source).

The compensation current I_{B} is proportional to the Triac leading edge peak detect signal 428/628 (that is the same as the leading edge peak of the rectified voltage). However, since the compensation current I_{B} is subtracted from the maximum bias current I_{A} to generate the biasing/control current I_{C} of the preload switching device 469/669, the current through the quasi-phase active preload resistor (in the example of a BJT transistor, current though Collector-Emitter of the preload switching device) may be inversely proportional to the leading edge peak detect signal, which means reduction of the leading edge peak detect signal, the preload current increases.

In FIG. 7B, Triac cut-off phase interval φ_{cut} 742 corresponds to the time that the compensation transistor 480/680 is in an off-state and the full bias current is being supplied to the bias capacitor 466/666 and the quasi-phase active preload switching device 469/669. During this phase interval φ_{cut} 742, the quasi-phase active preload switching device may conduct the full current 743 and voltage across the quasi-phase active preload switching device 741 remains substantially at zero. During the conduction phase interval φ_{cond} 744 that the compensation transistor 480/680 starts conducting in linear mode, the bias current supplied to the bias capacitor 466/666 and to the quasi-phase active preload switching device 469/669 is reduced by the compensation current sank through the compensation transistor 480/680. As a result, the preload current 745 through the quasi-phase active preload switching device reduces towards zero, the voltage across the quasi-phase active preload switching device 740 increases towards the output rail voltage, and the preload switching device turns off. At the next Triac cut-off phase interval in which the full bias current is again supplied to the bias capacitor 466/666 and to the quasi-phase active preload switching device 469/669, the quasi-phase active preload switching device may begin conducting again. During the time interval 746, current rises towards full current and voltage across the quasi-phase active preload switching device drops back towards zero.

FIG. 7C depicts some examples of voltage waveform across the preload switching device at different conditions. During non-dimming operation in which the quasi-phase active preload switching device remains in an off-state, the voltage 750 across the preload switching device remains steadily high at the output voltage. During low-dimming operation in which the quasi-phase active preload switching device is functioning in a linear mode, the voltage 760 across the preload switching device during conduction interval of the Triack ni each line half cycle changes from zero to the full rail voltage as described above with respect to FIG. 7B. During the LED off-condition with a leaky Triac, the quasi-phase active preload switching device remains in on-state (voltage 770 across the quasi-phase active preload switching device is substantially zero) to prevent any undesirable turning ON of the LED, thereby preventing flickering in the LED.

The above description of illustrative examples is not intended to be exhaustive. Although specific implementations of, and examples for, are described herein for illustrative purposes, various equivalent modifications are possible without departing from the broader spirit and scope. Indeed, it is appreciated that the specific example voltages, currents, frequencies, power range values, times, etc., are provided for explanation purposes and that other values may also be employed in other embodiments and examples in accordance with these teachings.

These modifications can be made to examples of the invention in light of the above detailed description. The terms used in the following claims should not be construed to limit the invention to the specific embodiments disclosed in the specification and the claims. The present specification and figures are, accordingly, to be regarded as illustrative rather than restrictive.

What is claimed is:

1. An active preload circuit configured to be coupled to an output of a non-isolated light-emitting diode (LED) driver converter having a phase-angle control dimmer circuit, the active preload circuit comprising:
a preload resistor coupled to the output of the non-isolated LED driver converter; and
a current-controlled current source coupled to receive a peak detect signal representative of a conduction angle of the phase-angle control dimmer circuit, wherein the current-controlled current source is configured to draw a variable sinking current through the preload resistor, and wherein a value of the sinking current is based on the peak detect signal.

2. The active preload circuit of claim 1, wherein the phase-angle control dimmer circuit comprises a leading edge control Triac dimmer.

3. The active preload circuit of claim 1, wherein the peak detect signal is representative of a leading-edge peak voltage of an output of the phase-angle control dimmer circuit.

4. The active preload circuit of claim 1, wherein when the peak detect signal is above an upper threshold value, a switching device of the current-controlled current source is configured to be in an OFF state operating in an open circuit mode to cause a value of the sinking current to be substantially zero.

5. The active preload circuit of claim 4, wherein the upper threshold value corresponds to an upper threshold of the conduction angle of the phase-angle control dimmer circuit.

6. The active preload circuit of claim 1, wherein when the peak detect signal is below a lower threshold value, a switching device of the current-controlled current source is configured to be in an ON state to cause a value of the sinking current to have a maximum value.

7. The active preload circuit of claim 1, wherein the current-controlled current source comprises:
a voltage-controlled current source configured to draw a compensation current proportional to a voltage of the peak detect signal; and
a switching device coupled to draw the sinking current in response to a control signal, wherein the control signal is equal to a maximum bias current minus the compensation current.

8. The active preload circuit of claim 1, wherein when the peak detect signal is between an upper threshold value and a lower threshold value, a switching device of the current-controlled current source is configured to operate in a linear mode in response to the peak detect signal.

9. The active preload circuit of claim 1, wherein the current-controlled current source comprises a Darlington combination of a first BJT transistor and a second BJT transistor, and wherein the first BJT transistor is configured to draw the sinking current through the preload resistor.

10. The active preload circuit of claim 9, wherein the Darlington combination of the first BJT transistor and the second BJT transistor is controlled by a control current, and wherein the control current is generated by a voltage-controlled current source that is controlled by a scaled version of the peak detect signal.

11. The active preload circuit of claim 1, wherein the variable sinking current has a minimum value of zero amperes.

12. The active preload circuit of claim 1, wherein the current-controlled current source is coupled to receive the peak detect signal from a peak detector circuit, the peak detector circuit comprising:
a capacitor coupled to a first output terminal of the phase-angle control dimmer circuit;
a diode coupled between the capacitor and a second output terminal of the phase-angle control dimmer circuit; and
a resistor coupled between the capacitor and the second output terminal of the phase-angle control dimmer circuit.

13. The active preload circuit of claim 1, wherein the non-isolated LED driver converter is a Buck-Boost converter.

14. The active preload circuit of claim 1, wherein the non-isolated LED driver converter is a Buck or Tapped Buck converter, and wherein a Buck switch or a Buck inductor of the non-isolated LED driver converter generates a level difference between an input return and an output return of the non-isolated LED driver converter.

15. A light-emitting diode (LED) driver comprising:
a phase-angle control dimmer circuit coupled to receive an input voltage and output a phase-adjusted voltage;
a rectifier circuit coupled to receive the phase-adjusted voltage and output a rectified voltage;
a peak detector circuit coupled to receive the rectified voltage and generate a peak detect signal representative of a conduction angle of the phase-angle control dimmer circuit;
a non-isolated converter coupled to receive the rectified voltage and output an output voltage;
an active preload circuit coupled to an output of the non-isolated converter, wherein the active preload circuit comprises:
a preload resistor coupled to the output of the non-isolated converter; and
a current-controlled current source coupled to receive the peak detect signal from the peak detector circuit, wherein the current-controlled current source is configured to draw a variable sinking current through the preload resistor, and wherein a value of the sinking current is based on the peak detect signal.

16. The LED driver of claim 15, wherein the phase-angle control dimmer circuit comprises a Triac dimmer.

17. The LED driver of claim 15, wherein the peak detect signal is representative of a leading-edge peak voltage of the phase-adjusted voltage.

18. The LED driver of claim 15, wherein when the peak detect signal is above an upper threshold value, a switching device of the current-controlled current source is configured to be in an OFF state operating in an open circuit mode to cause the sinking current to have a substantially zero value.

19. The LED driver of claim 15, wherein when the peak detect signal is below a lower threshold value, a switching device of the current-controlled current source is configured to be in an ON state operating in a short circuit mode to cause the value of the sinking current to be a maximum value.

20. The LED driver of claim 15, wherein when the peak detect signal is between an upper threshold value and a lower threshold value, a switching device of the current-controlled current source is configured to operate in a linear mode in response to the peak detect signal.

21. The LED driver of claim 15, wherein the current-controlled current source comprises a Darlington combination of a first BJT transistor and a second BJT transistor, and wherein the first BJT transistor is configured to draw the sinking current through the preload resistor.

22. The LED driver of claim 15, wherein the peak detector circuit comprises:
a capacitor coupled to a first output terminal of the phase-angle control dimmer circuit;
a diode coupled between the capacitor and a second output terminal of the phase-angle control dimmer circuit; and
a resistor coupled between the capacitor and the second output terminal of the phase-angle control dimmer circuit.

23. The LED driver of claim 15, wherein the non-isolated converter is a Buck-Boost converter.

24. The LED driver of claim 15, wherein the non-isolated converter is a Buck or Tapped Buck converter, and wherein a Buck switch or a Buck inductor of the non-isolated converter generates a level difference between an input return and an output return of the LED driver.

25. The LED driver of claim 15, wherein the current-controlled current source comprises:
a voltage-controlled current source configured to draw a compensation current proportional to a voltage of the peak detect signal; and
a switching device coupled to draw the sinking current in response to a control signal, wherein the control signal is equal to a maximum bias current minus the compensation current.
